(19) United States
(12) Patent Application Publication
(10) Pub. No.: US 2013/0321013 A1
(43) Pub. Date: Dec. 5, 2013

(54) PHOTOVOLTAIC DEVICE FOR MEASURING IRRADIANCE AND TEMPERATURE

(71) Applicants: Stephen G. Pisklak, Hockessin, DE (US); David L. King, Albuquerque, NM (US); Michael J. Lesniak, Midland, MI (US); Narayan Ramesh, Midland, MI (US)

(72) Inventors: Stephen G. Pisklak, Hockessin, DE (US); David L. King, Albuquerque, NM (US); Michael J. Lesniak, Midland, MI (US); Narayan Ramesh, Midland, MI (US)

(73) Assignee: Dow Global Technologies LLC, Midland, MI (US)

(21) Appl. No.: 13/990,975

(22) PCT Filed: Nov. 21, 2011
(86) PCT No.: PCT/US11/61606

§ 371 Date: Aug. 9, 2013

Related U.S. Application Data
(60) Provisional application No. 61/419,136, filed on Dec. 2, 2010.

(51) Int. Cl. G01R 31/40

(52) U.S. Cl. CPC H02S 50/00
USPC 324/750.3

(57) ABSTRACT

A solar array system includes a plurality of power-generator modules, each power-generator module having an identical form factor and comprising a plurality of photovoltaic cells wired for power generation. The system also includes at least one sensor module having a substantially identical appearance and form factor as the power-generator modules and comprising a like plurality of photovoltaic cells. The operational state of the system is monitored by an array performance monitor, which measures signals sent from the various modules. At least one photovoltaic cell in the sensor module delivers a short-circuit current signal to the array performance monitor and at least one photovoltaic cell in the sensor module delivers an open-circuit voltage signal to the array performance monitor. These signals are used to calculate a theoretical power output of the array system, which is compared to the actual power output.

This application is being filed on 21 Nov. 2011, as a PCT International Patent application in the name of Dow Global Technologies LLC, a U.S. national corporation, applicant for the designation of all countries except the U.S., and, Stephen G. Pisklak, a citizen of the U.S., David L. King, a citizen of the U.S., Michael J. Lesniak, a citizen of U.S., and Narayan Ramesh, a citizen of India, applicants for the designation of the U.S. only, and claims priority to U.S. patent application Ser. No. 61/419,136 filed on 2 Dec. 2010, the disclosure of which is incorporated herein by reference in its entirety.

### INTRODUCTION

The vast majority of solar array monitoring systems currently on the market monitor only the solar array output. These array monitoring systems give no indication of whether or not the solar array is functioning as designed. In order to provide such information, irradiance and module temperature must be measured concurrently and at the same location as the array. In commercial installations, this is typically done with a weather monitoring station. Such weather monitoring stations may include a panel temperature sensor, an outside temperature and relative humidity sensor, a pyranometer (for measuring irradiance), and a wind speed and wind direction sensor. These components take the form of a number of cubical and cylindrical housings (for the outside temperature/RH sensor and pyrometer), and vaned impellers mounted on one or more support structures proximate the array. For a residential installation, in which building aesthetics play an important role, such a weather monitoring station is impractical. Residential monitoring systems, therefore, rarely monitor array performance, only output.

### SUMMARY

The proposed technology utilizes, in one embodiment, a sensor module having substantially the same the appearance and form factor of power-generator modules in a solar array. The signals sent from this sensor module may be processed and compared to the output of the power-generator modules to determine an operational state of the array.

In one aspect, the technology relates to a solar array system including: a plurality of power-generator modules, each power-generator module having an identical form factor and including a plurality of photovoltaic cells wired for power generation; at least one sensor module having a substantially identical appearance and form factor as the power-generator modules and including a like plurality of photovoltaic cells; an array performance monitor; and wherein at least one photovoltaic cell in the sensor module delivers a short-circuit current to the array performance monitor and at least one photovoltaic cell in the sensor module delivers an open-circuit voltage to the array performance monitor.

In another aspect, the invention relates to a solar array kit useful in forming a solar array system, the kit including: an array performance monitor; a plurality of power-generator modules including connectors for communicating with the array performance monitor, each power-generator module having an identical form factor and including a plurality of photovoltaic cells; and at least one sensor module including connectors for communicating with the array performance monitor, the at least one sensor module having a substantially identical appearance and form factor as the power-generator modules and including a like plurality of photovoltaic cells, wherein at least one photovoltaic cell in the sensor module is adapted to deliver a short-circuit current to the array performance monitor and at least one photovoltaic cell in the sensor module is adapted to deliver an open-circuit voltage to the array performance monitor.

In another aspect, the invention relates to a method of determining an operational state of a solar array, the method including: providing a photovoltaic module array including at least one sensor module and at least one power-generator module, wherein the sensor module and power-generator module are substantially identical in appearance and form factor; providing a receiver for receiving a signal from each of the sensor module and the power-generator module; measuring a first signal from the power-generator module, wherein the first signal includes a power output; measuring a second signal sent from the sensor module, wherein the second signal includes at least one of a short-circuit current and an open-circuit voltage; providing a processor for processing the first signal and the second signal; and determining the operational state of the solar array based at least in part on the first signal and the second signal.

In another aspect, the invention relates to a sensing module for a solar array system including: a first photovoltaic cell wired to generate a short-circuit current; and a second photovoltaic cell wired to generate an open-circuit voltage.

### BRIEF DESCRIPTION OF THE DRAWINGS

There are shown in the drawings, embodiments which are presently preferred, it being understood, however, that the technology is not limited to the precise arrangements and instrumentalities shown.

FIG. 1A is a schematic diagram of a solar array system.

FIG. 1B is an alternative schematic diagram of a solar array system.

FIG. 2A is a schematic diagram of a sensing module.

FIG. 2B is a schematic circuit diagram for converting an output signal of a photovoltaic cell.

FIG. 2C is an alternative schematic diagram of a photovoltaic module.

FIGS. 3A and 3B depict a method of determining an operational state of a solar array.

### DETAILED DESCRIPTION

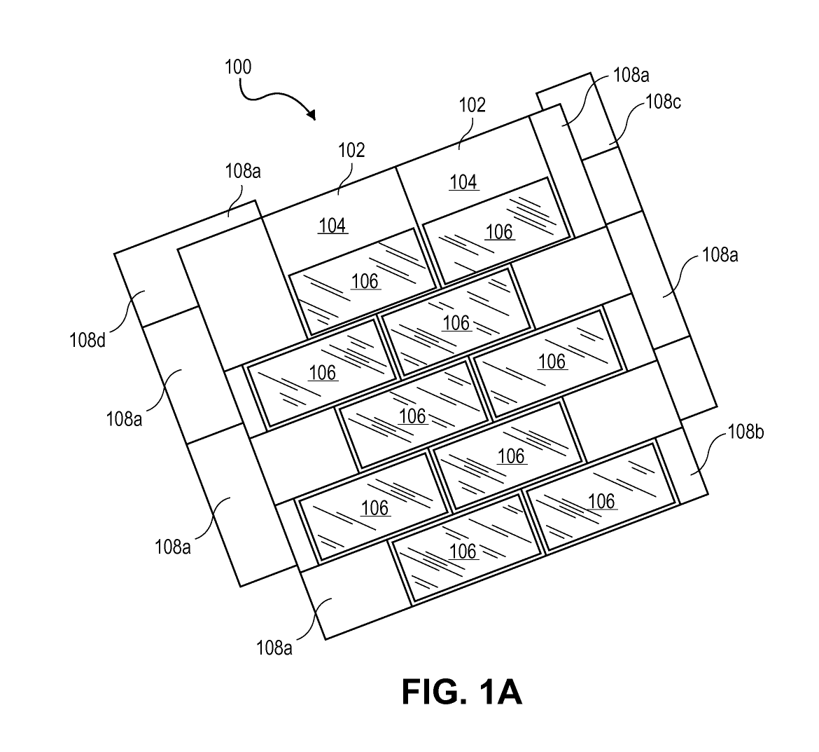

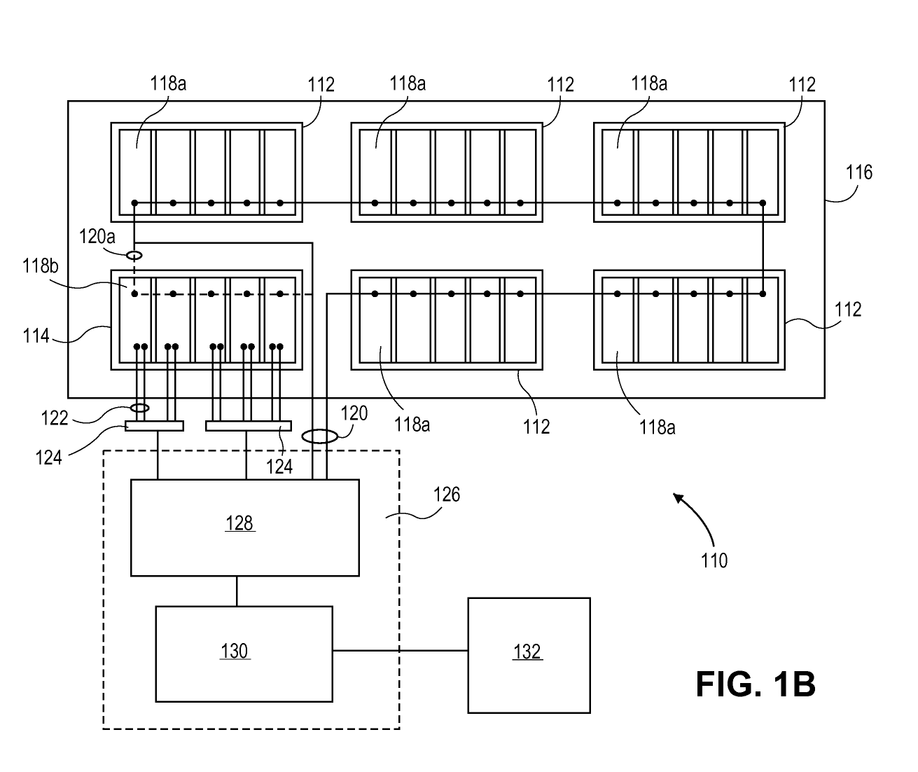

FIG. 1A depicts an installation of a solar array system 100 which may be used in conjunction with the systems and methods described herein. The system 100 includes a number of building integrated photovoltaic devices 102 that include both a body portion 104 and a photovoltaic cell module 106. The system 100 may include at least one edge piece 108a located at the end or within the at least two rows/columns of photovoltaic devices 102. Additionally, at least one starter piece 108b, at least one filler piece 108c, and at least one end piece 108d may be utilized. These components, as well as elements used for connection of these components, are described in International Publication Number WO 2009/137353, the disclosure of which is hereby incorporated by reference herein in its entirety.

FIG. 1B depicts an embodiment of a solar array system 110. The solar array system 110 includes a plurality of power-generator modules 112 and one sensor module 114 installed, in this case, on a roof 116 of a building or other structure. In the depicted embodiment, five power-generator modules 112 and one sensor module 114 are utilized. Any number of power-generator modules and sensor modules may be installed, however, as desired for a particular application. For residential applications, the maximum array square footage is often limited by, for example, roof size. Accordingly, a single sensor module utilized with any number of power generator modules may be desirable. In particularly large installations, however, two or more sensor modules may be used in a particular array. For example, large commercial array applications having several blocks or groupings of modules may include a sensor module for each block of power-generator modules.

The technology described herein has particular application in the residential solar market because the sensor modules are substantially identical to the power generator modules in appearance and form factor. Dimensions of the two types of modules, as well as the number of photovoltaic cells contained in each, may be substantially the same. Array systems utilizing differently sized and configured power-generator modules and sensor modules are also contemplated. One application where identical modules may be desirable are building integrated solar array systems, where aesthetics may be a significant determining factor.

Modules may be building integrated solar modules, also referred to as a building integrated photovoltaics (BIPV), which may be used to replace conventional building materials in parts of a building envelope such as the roof, skylights, or facades. The module may be a thin film solar cell integrated to a flexible polymer roofing membrane, a module configured to resemble one or more roofing shingles (for example, the POWERHOUSE brand of BIPV shingles manufactured by the Dow Chemical Company), or semitransparent modules used to replace architectural elements commonly made with glass or similar materials, such as windows and skylights. Alternatively, the solar module may be a rigid solar module mounted to an architectural element such as a roof or installed within a large field array. In short, the technology is not limited to building integrated photovoltaic or arrays having discrete sensor modules and generator modules. The concepts, operation, and functionality described herein may be used with any desired configuration where use of a dedicated weather monitoring station is undesirable.

Returning to FIG. 1B, each of the power-generator modules 112 contains five photovoltaic cells 118a. A power circuit 120 connected to the power-generator modules 112 is wired in series, as typical for solar applications. The sensor module 114 also contains five photovoltaic cells 118b. Sensor circuits 122 are wired individually to each photovoltaic cell 118b, as described in more detail below. The system 110 also includes one or more driver/comparator circuits 124, as described below. An array performance monitor 126 includes an input/output (I/O) module 128 for receiving the signals sent from the power-generator modules 112 and the sensor module 114. A processor 130 performs the calculations and other comparisons described herein. The array performance monitor 126 may be a solar array control system, a stand-alone PC, or other controlling or monitoring device or system. The solar array system 126 may power various types of equipment 132, as desired for the particular application. Other components of the array system 110 are described below.

The array system 110 may include an optional sensor module power circuit 120a. The optional sensor module power circuit 120a is wired to the power circuit 120 and allows the sensor module 114 to be used for power generation, if desired. The wiring configuration for the sensor module power circuit 120a is depicted schematically. Other configurations are contemplated and will be apparent to a person of skill in the art. In other embodiments, the I/O module 128 may be replaced with a receiver. An I/O module may be desirable, however, for applications that include one or more bypass circuits in the power circuit 120 to bypass damaged cells and/or modules. Damaged cells or modules are known to reduce the efficiency of solar array systems and bypassing such components may be desirable in certain applications. Additionally, control circuitry or programs may be incorporated into the array performance monitor 126 to allow for either manual or automatic activation of the sensor module power circuit 120a, bypass circuits, or other functions.

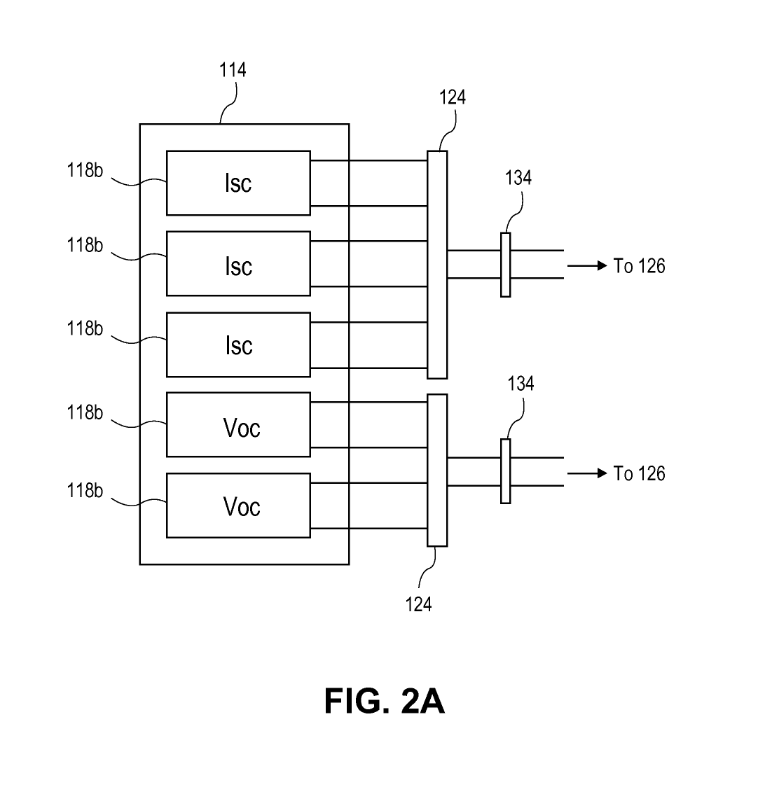

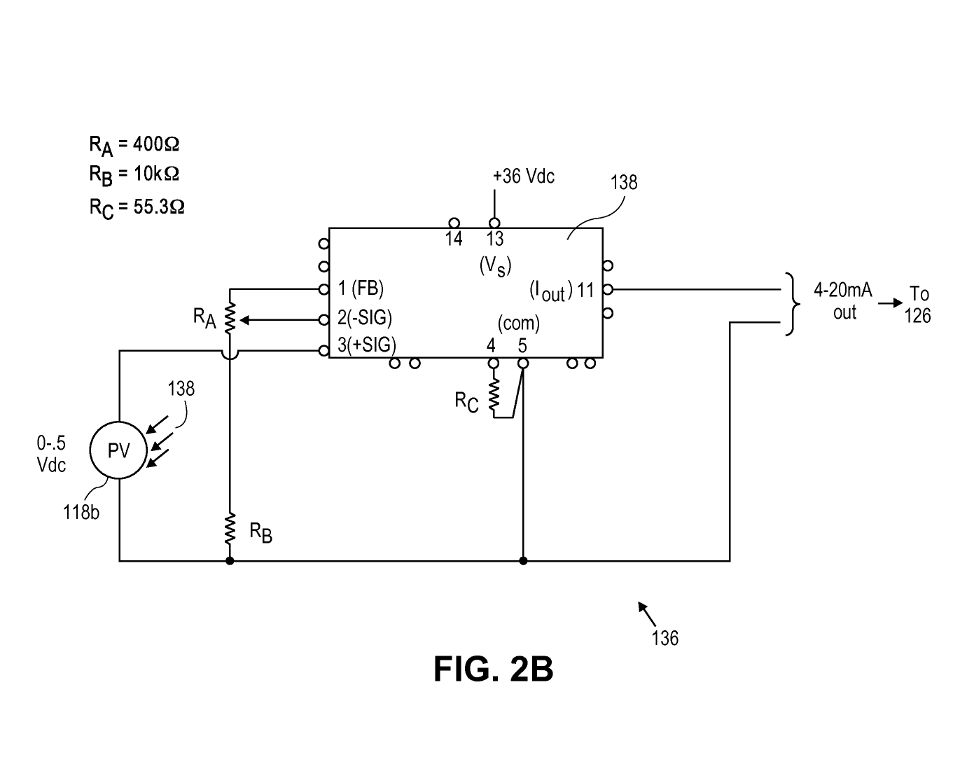

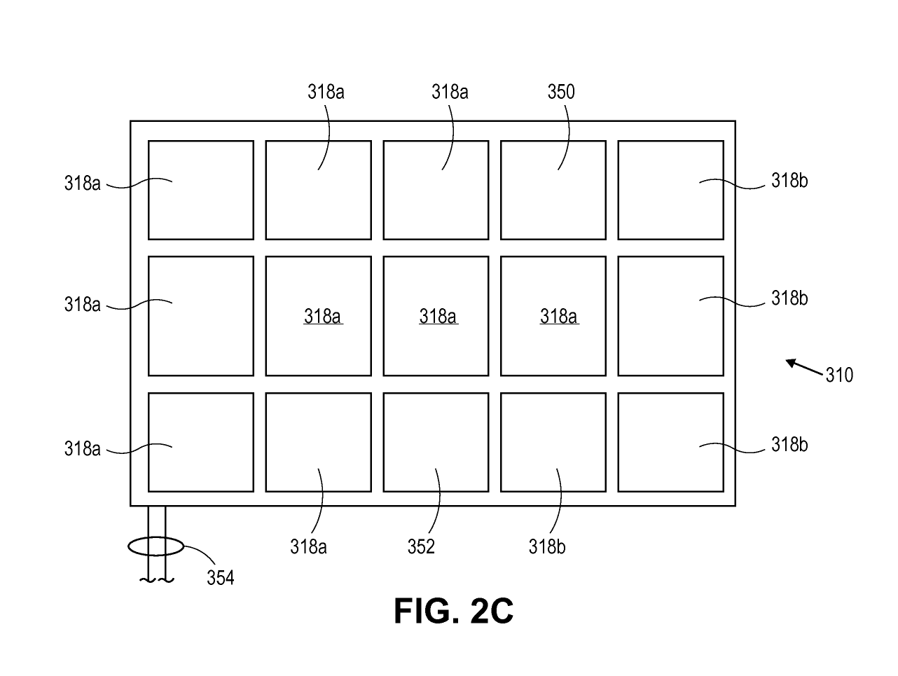

FIG. 2A depicts an embodiment of a sensing module 114. The depicted module 114 includes five photovoltaic cells 118b. Three short-circuit current cells I_{sc} are wired to deliver a signal that may be used to determine an irradiance value for an array. Two open-circuit voltage cells V_{oc} are wired to deliver a signal that may be used to determine a cell temperature. The driver comparator circuit 124 and a signal conditioner 134 are also depicted. The output from the signal conditioner 134 is delivered to the array performance monitor 126. In the depicted embodiment, the driver/comparator circuit 124 and signal conditioner 134 are discrete from the sensor array 114. These components 124, 134 may be combined into a circuit, separate from both the sensor module 114 and the array performance monitor 126, for example, in a component located below a roof surface, proximate the array. It is contemplated that the components 124, 134 also may be incorporated into the sensor module 114, for example, in a recess located on the underside of the sensor module. Alternatively, the components 124, 134 may be incorporated into the I/O module 128 or the processor 130 of the array performance monitor system 126 depicted in FIG. 1B.

Any number of short-circuit current cells I_{sc} and open-circuit voltage cells V_{oc} may be utilized, as desired for a particular application. Use of multiple cells allows for preliminary processing, such as signal integrity checking, signal averaging, other functions, or combinations thereof. This preliminary processing may be performed by the driver/comparator circuit 124. This pre-processing may improve accuracy of output from the cells 118b. The signals sent from the cells 118b may be 0-0.5 V_{dc}. After processing, the output from the signal conditioner 134 is a 4-20 mA signal that is proportional to both of the irradiance incident to the cell and the cell temperature. This signal is then sent to the array performance monitor 126 for further calculations. The 4-20 mA output signal from the short-circuit current cells I_{sc} may be converted into an irradiance value using, in one embodiment, the following formula:

E=A₃I_{E}-A₄ (i)

where E represents irradiance, I_{E} is a 4-20 mA signal associated with Isc, A₃ is a constant between 56 and 75, and A₄ is a constant between 125 and 300. The constants are based on the output and input scales. Other constants may be utilized in other embodiments. The signal from the open-circuit voltage cells V_{oc} may be converted into a cell temperature value using, in one embodiment, the following formula:

T=A₁I_{T}-A₂ (ii)

where T represents temperature, I_{T} is 4-20 mA signal associated with Voc, Aₗ is a constant between 9.3 and 10.4, and A₂ is a constant between 81 and 88. Again, the constants are based on the output and input scales, and other constants may be utilized in other embodiments. However, these are but examples of formulas of that may be used to determine the irradiance and cell temperature. Other formulas will be apparent to a person of skill in the art.

FIG. 2B is a schematic of an embodiment of one possible circuit diagram 136 for converting an output signal from a photovoltaic cell 118b. The photovoltaic cell 118b may be the short-circuit current cell I_{Sc} for irradiance measurement or the open-circuit voltage cell V_{oc} for cell temperature measurement. The photovoltaic cell 118b outputs a 0-0.5 V_{dc} signal based upon energy 138 received from a solar power source (i.e., the sun). After the pre-processing by the driver/comparator described above, the circuit converts the circuitry output signal into a 4-20 mA signal that is sent to the array performance monitor 126 for further processing. In this embodiment, the circuit utilizes an AD 694 monolithic current transmitter 138, manufactured by Analog Devices, Inc. Other acceptable circuit configurations based on different chips or other combinations of hardware, software, and firmware will be apparent to a person of skill in the art.

FIG. 2C depicts an alternative embodiment of a solar module 310. The solar module 310 may be a BIPV or other type of module, as described above. The solar module 310 includes a number of sensor cells 318b. Additionally, a reference current generator cell 350 may be incorporated into the module 310. The reference current generator cell 350 generates a reference current that may be used to determine cell degradation. Photovoltaic cells lose efficiency over time but, since the various cells (power-generator, sensor, reference) are constructed of the same material, they will degrade at a similar rate. Accordingly, use of a reference current generator cell allows an associated array performance monitor to determine if decreased efficiency of a particular cell is due to general cell degradation or to cell damage that may necessitate replacement. A differential-pressure wind-speed sensor may also be incorporated therein. Such wind-speed sensors are manufactured for example by Sensiron under the model name ASP1400. The remaining cells in the module 310 may be power-generator cells 318a. The various internal wiring circuits are not shown in FIG. 2C, for clarity. A single wiring bundle 354 may be used for all circuits, to limit penetrations to the interior of the module 310, as well as for ease of installation. Such a solar module 310 may be used as a stand-alone power source, incorporating performance data output, which may be used to determine an operational state of the module 310.

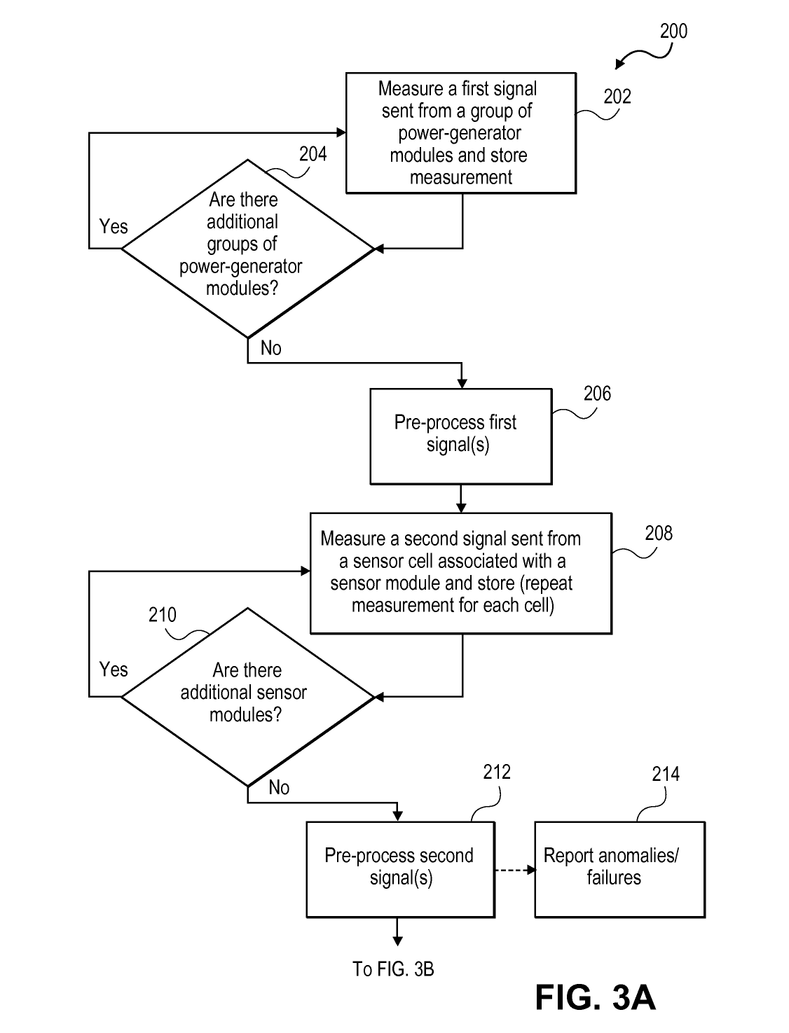

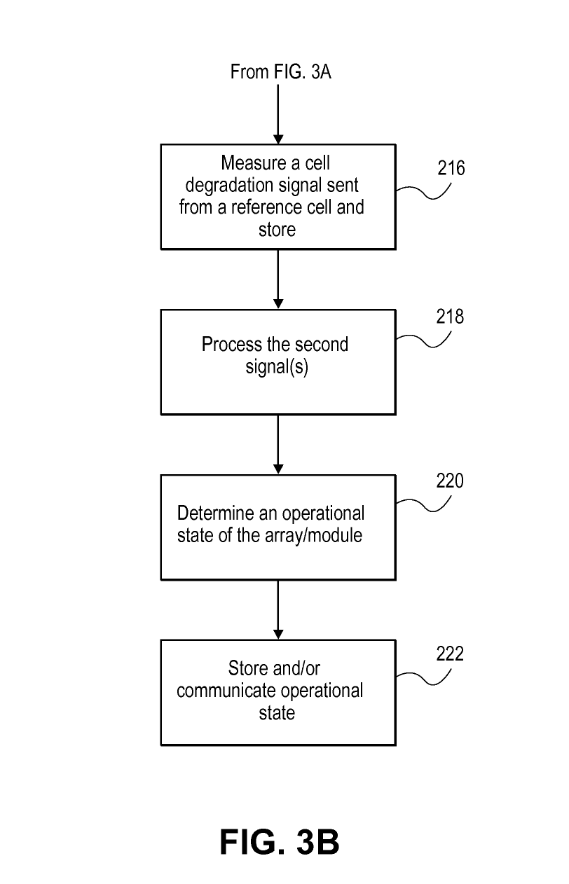

FIG. 3 depicts an embodiment of a method 200 of determining an operational state of a solar array. The method 200 described below may also be used to determine the operational state of the stand-alone module 310 described above in FIG. 2C, or many other configurations of solar arrays or modules that utilize non-power-generating photovoltaic cells to determine an operational state of an array or module. If used in the context of an array, the method contemplates a sensor module having a plurality of photovoltaic cells, where certain of those cells generate a signal corresponding to a short-circuit current for determining an irradiance value, and where certain of those cells generate a signal corresponding to an open-circuit voltage for determining an cell temperature. The array system also includes a receiver (alternatively, and I/O module) and an array performance monitor, including a processor.

The method 200 includes measuring a first signal sent from a group of power-generator modules (Step 202). In this case, each group of power-generator modules is associated with a single sensor module. This first signal corresponds to a power output from the group of power-generator modules. In most cases, a single power output will be delivered from the power-generator modules in the array. However, the method does contemplate multiple power outputs from the array, for example, where certain power-generator modules produce dedicated power outputs for particular applications or equipment, or when multiple groups are present in large-scale field array applications. If multiple groups are present (Step 204), the method measures signals from each group of power-generator modules and stores these multiple signals (Step 202) as well. The method 200 then pre-processes the multiple signals (Step 206). This pre-processing may include determining a total combined power output for the array, or storing each of the power outputs for later comparison to the corresponding signals from the sensor module(s).

The method 200 includes measuring a second signal sent from a sensor cell within a sensor module (Step 208). Multiple signals corresponding to an equivalent number of sensor cells are measured. These signals correspond to either a short-circuit current or an open-circuit voltage. If multiple groups are present (Step 210), the method measures signals from each group of sensor modules and stores these multiple signals (Step 208) as well. These second signals may be pre-processed (Step 212). For example, either or both of the signals types (i.e., short-circuit current, open-circuit voltage) may be averaged, high and/or low signal values may be disregarded, or null signal values or other signal values that may indicate an error or cell failure may be identified. The latter circumstances may be reported as anomalies or failures to the array performance monitor (Step 214), indicating that service or replacement of a module may be required. Additionally, signal values that correspond to groups of power-generator modules having dedicated power outputs (see Step 202, above) may be stored separately. If present, a reference current signal may be received from reference cell, and subsequently measured and stored (Step 216).

Once the various signals are measured and stored, the second signals may be processed to convert the values received into a calculated power output for each group of power-generator modules (Step 218). This calculated power output may then be compared to the actual power output (i.e., the first signal(s)) to determine an operational state of a group of modules or the entire array (Step 220). A basic operational state is an efficiency rating that relates to the percentage of actual power produced versus the calculated value that should be produced based on irradiance and cell temperature. This operational state may then be stored and/or communicated to an operator of the array system, a service provider, or other entity or device (Step 222). Various types of communications are contemplated. For example, a monitoring system panel light may be illuminated or warning message sent when the calculated value deviates by a predetermined percentage or value from the actual power output.

The solar array system described above may be sold as a kit, either in a single package or in multiple packages. A kit may include an array performance monitor, a sensor module, and one or more power-generator modules, or each of these components may be sold separately. Each module, as well as the array performance monitor, includes a plurality of connectors for communication between the various system components. If desired, wiring may be included, although instructions included with the kit may also specific the type of wiring required based on the particular installation. Additional sensor modules and power-generator modules may be available separately, so an array field of a desired size may be assembled. Additionally, the array performance monitor may be loaded with the necessary software or firmware required for use of the system. In alternative configurations, software may be included on various types of storage media (CDs, DVDs, USB drives, etc.) for upload to a standard PC, if the PC is to be used as the array performance monitor, or if the PC is used in conjunction with the array performance monitor as a user or service interface. Additionally, website addresses and passwords may be included in the kit instructions for programs to be downloaded from a website on the Internet.

The technology described herein can be realized in hardware, software, or a combination of hardware and software. The technology described herein can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The technology described herein also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

In the embodiments described above, the software may be configured to run on any computer or workstation such as a PC or PC-compatible machine, an Apple Macintosh, a Sun workstation, a dedicated array monitoring system, etc. In general, any device can be used as long as it is able to perform all of the functions and capabilities described herein. The particular type of computer, workstation, or system is not central to the technology, nor is the configuration, location, or design of a database, which may be flat-file, relational, or object-oriented, and may include one or more physical and/or logical components.

The servers may include a network interface continuously connected to the network, and thus support numerous geographically dispersed users and applications. In a typical implementation, the network interface and the other internal components of the servers intercommunicate over a main bi-directional bus. The main sequence of instructions effectuating the functions of the technology and facilitating interaction among clients, servers and a network, can reside on a mass-storage device (such as a hard disk or optical storage unit) as well as in a main system memory during operation. Execution of these instructions and effectuation of the functions of the technology is accomplished by a central-processing unit (“CPU”).

A group of functional modules that control the operation of the CPU and effectuate the operations of the technology as described above can be located in system memory (on the server or on a separate machine, as desired). An operating system directs the execution of low-level, basic system functions such as memory allocation, file management, and operation of mass storage devices. At a higher level, a control block, implemented as a series of stored instructions, responds to client-originated access requests by retrieving the user-specific profile and applying the one or more rules as described above.

Data communication may take place via any media such as standard telephone lines, LAN or WAN links (e.g., T1, T3, 56kb, X.25), broadband connections (ISDN, Frame Relay, ATM), wireless links, and so on. Preferably, the network can carry TCP/IP protocol communications, and HTTP/HTTPS requests made by the client and the connection between the client and the server can be communicated over such TCP/IP networks. The type of network is not a limitation, however, and any suitable network may be used. Typical examples of networks that can serve as the communications network include a wireless or wired Ethernet-based intranet, a local or wide-area network (LAN or WAN), and/or the global communications network known as the Internet, which may accommodate many different communications media and protocols.

While there have been described herein what are to be considered exemplary and preferred embodiments of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

1. A solar array system comprising:
a plurality of power-generator modules, each power-generator module having an identical form factor and comprising a plurality of photovoltaic cells wired for power generation;
at least one sensor module having a substantially identical appearance and form factor as the power-generator modules and comprising a like plurality of photovoltaic cells;
an array performance monitor; and
wherein at least one photovoltaic cell in the sensor module delivers a short-circuit current to the array performance monitor and at least one photovoltaic cell in the sensor module delivers an open-circuit voltage to the array performance monitor.

2. The solar array system of claim 1, wherein the plurality of power-generator modules generates a first signal comprising a power output, and wherein the at least one sensor module generates a second signal comprising at least one of the short-circuit current and the open-circuit voltage.

3. The solar array system as in claim 1, wherein the array performance monitor comprises a processor for processing the first signal and the second signal and determining an operational state of the solar array based at least in part on the first signal and the second signal.

4. The solar array system as in claim 1, wherein the short-circuit current corresponds to an irradiance value for the solar array system, and wherein the open-circuit voltage corresponds to a cell temperature value for the solar array system.

5. The solar array system as in claim 1, wherein the sensor module comprises a plurality of photovoltaic cells, wherein at least a first sensor module photovoltaic cell is wired to generate a short-circuit current and at least a second sensor module photovoltaic cell is wired to generate an open-circuit voltage.

6. The solar array system as in claim 1, wherein the sensor module comprises at least three first sensor module photovoltaic cells and at least two second sensor module photovoltaic cells.

7. The solar array system as in claim 5, wherein each of the first sensor module photovoltaic cells is wired to generate a short-circuit current, and wherein each of the second sensor module photovoltaic cells is wired to generate an open-circuit voltage.

8. The solar array system of claim as in claim 1, wherein the sensor module further comprises at least one of a reference photovoltaic cell wired to generate a reference current corresponding to a photovoltaic cell degradation value and a differential pressure wind-speed sensor.

9. The solar array system of claim as in claim 1, further comprising a bus for communication between the at least one sensor module and the array performance monitor.

10. A solar array kit useful in forming a system as in claim 1 comprising:
an array performance monitor;
a plurality of power-generator modules comprising connectors for communicating with the array performance monitor, each power-generator module having an identical form factor and comprising a plurality of photovoltaic cells; and
at least one sensor module comprising connectors for communicating with the array performance monitor, the at least one sensor module having a substantially identical appearance and form factor as the power-generator modules and comprising a like plurality of photovoltaic cells,
wherein at least one photovoltaic cell in the sensor module is adapted to deliver a short-circuit current to the array performance monitor and at least one photovoltaic cell in the sensor module is adapted to deliver an open-circuit voltage to the array performance monitor.

11. The solar array kit of claim 10, wherein the array performance monitor comprises a processor adapted for processing a first signal sent from the plurality of power-generator modules and a second signal sent from the at least one sensor module.

12. The solar array kit as in claim 10, wherein the sensor module comprises a plurality of sensor module photovoltaic cells, wherein each sensor module photovoltaic cell is adapted to send a signal to the array performance monitor.

13. The solar array kit as in claim 10, wherein the sensor module comprises at least three first sensor module photovoltaic cells and at least two second sensor module photovoltaic cells.

14.-15. (canceled)

16. A method of determining an operational state of a solar array, the method comprising:
providing a photovoltaic module array comprising at least one sensor module and at least one power-generator module, wherein the sensor module and power-generator module are substantially identical in appearance and form factor;
providing a receiver for receiving a signal from each of the sensor module and the power-generator module;
measuring a first signal from the power-generator module, wherein the first signal comprises a power output;
measuring a second signal sent from the sensor module, wherein the second signal comprises at least one of a short-circuit current and an open-circuit voltage;
providing a processor for processing the first signal and the second signal; and
determining the operational state of the solar array based at least in part on the first signal and the second signal.

17. The method of claim 16, wherein the short-circuit current corresponds to an irradiance value for the solar array system, and wherein the open-circuit voltage corresponds to a cell temperature value for the solar array system.

18. The method as in claim 16, wherein the sensor module comprises a plurality of photovoltaic cells, wherein at least a first sensor module photovoltaic cell delivers a short-circuit current, and wherein at least a second sensor module photovoltaic cell delivers an open-circuit voltage.

19. The method as in claim 16, wherein the sensor module comprises:
at least three first sensor module photovoltaic cells, wherein each of the first sensor module photovoltaic cells delivers a short-circuit current to the receiver; and
at least two second sensor module photovoltaic cells, wherein each of the second sensor module photovoltaic cells delivers an open-circuit voltage to the receiver.

20. The method of claim 19, further comprising averaging the values of the short-circuit currents and averaging the values of the open-circuit voltages.

21. The method as in claim 16, further comprising processing a cell degradation signal sent from a photovoltaic cells located in the sensor module.

22. A sensing module for a solar array system comprising:
a first photovoltaic cell wired to generate a short-circuit current; and
a second photovoltaic cell wired to generate an open-circuit voltage.

23.-24. (canceled)
